(19) United States
(12) Patent Application Publication
(10) Pub. No.: US 2004/0249872 A1
(43) Pub. Date: Dec. 9, 2004

(54) Method for preventing computer induced repetitive stress injuries (CRSI)

(76) Inventor: Kuan-Hong Hsieh, Taipei (TW)

Correspondence Address: BIRCH STEWART KOLASCH & BIRCH, PO BOX 747, FALLS CHURCH, VA, 22040-0747, US

(21) Appl. No.: 10/456,467

(22) Filed: Jun. 9, 2003

(51) Int. Cl. G06F 7/00

(52) U.S. Cl. 708/200

(57) ABSTRACT

A method for preventing Computer Induced Repetitive Stress Injuries (CRSI) that records operation statistics of the computer and calculates computer user's weighted fatigue level; and will automatically remind user of necessary guiders when the fatigue level reaches predetermined threshold, therefore CRSI is effectively prevented.

### BACKGROUND OF THE INVENTION

1. Field of Invention

The present invention relates to a method of displaying a guider on the computer. More specifically, the invention relates to a method that automatically starts auxilliary relaxing guider on the screen based on operation statistics of the computer, therefore, Computer Induced Repetitive Stress Injuries (CRSI) is effectively prevented.

2. Related Art

In the new era of digital data and Internet, computer plays more and more important role in our life, work and entertainment and becomes one of the hi-tech products on which we depend greatly in daily life.

However, according to recent medical research, people suffer discomforts from long-term computer usage. Among all CRSI, the most often complained of are Computer Vision Syndrome (CVS) and Carpal Tunnel Syndrome (CTS) caused by long-term concentrating on the screen, repeated keystrokes and long periods of clutching and dragging with mouse. Generally speaking, computer users who use computer continuously over two hours per day are prone to incuding CVS. Reduced blinking frequency caused by long-term concentrating on the screen will make the moisture of the eyes vaporize rapidly and let people feel dryness on eyes and furthur induce chronic conjunctivitis and xerophthalmia. The flickering screen and reflex also aggravate eyestrain even further, so poor eyesight gets worst, eyestrain, headache, tiredness are often claimed by the users. CTS occur from repeated physical movements doing damage to tendon, nerves, muscles and other soft body tissues of hands. The thousands of repeated keystrokes and long periods of clutching and dragging with mouse slowly accumulate damage to the wrists and cause numbness and pain.

Those who suffer from CVS and CTS due to long-term computer usage should run for proper medical therapy immediately, otherwise, they would suffer permanent injury or painful sequel. However, compared with all the time and money it might involve during the therapy, CVS and CTS are far easier to prevent than to cure once contracted. Usually doctors suggest computer users to shorten the time to use computer and take regular break and hereby prevent CVS and CTS.

However, computer users are often too involved in work to take regular rest, or even though they do take some regular break, yet do not know what exercises can effectively help to relax eyes and wrists. Therefore, to develop a complete solution for preventing CRSI by providing a set of guider based on PC operation statistics becomes first concern of many software programmers. Some existing similar programs adopt “time” as one and only factor of the cause of CRSI and start guider after a predetermined time, which is not accurate for user's density and tension and the actual tiredness is not considered. Therefore, it is very important and more reasonable to improve the algorithm, and calculate the better timing to remind user when at a less busy statistics, so that the interference to the operation will be reduced as well.

### SUMMARY OF THE INVENTION

To solve the above-mentioned problem, the present invention provides a method for preventing CRSI that records operation statistics of the computer, including: keystrokes, clicking of the mouse, mouse scroll, page up and down, etc, and calculates computer user's weighted fatigue level; and will automatically remind user of guiders by poping up various guiders when the corresponding effective fatigue level reaches predetermined threshold, therefore CRSI is effectively prevented.

The method for preventing CRSI of the present invention comprises of following precedures: Start the program and read a plurality of predetermined settings; Pick PC operation statistics within each unit time and calculate weighted unit fatigue level and then accumulate an effective fatigue level; when the effective fatigue level reaches predetermined threshold, start guider corresponding to said threshold of fatigue level; and when said guider is finished, restart said effective fatigue level and re-calculate.

The method provided in the present invention can effectively prevent CRSI caused by long-term compuer usage, and can effectively help user with proper relaxation by running guider and displaying various guiders on the screen. Compared with some existing similar programs that adopt “time” as one and only factor for starting guider, the present invention is more accurate for user's actual tiredness with PC operation statistics and weighted effective fatigue level. Besides, unlike previous programs' popping up a guider suddenly and forcing user to stop current work to take a break, the present invention is more reasonable by calculating a better timing to remind user when at a less busy statistics, so that the interference to the operation will be reduced as well.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and thus are not limitative of the present invention, and wherein:

FIG. 1 is flow chart of the method for preventing CRSI of the present invention;

FIG. 2 is procedure and flow chart of calculating weighted effective fatigue level (Ym) in the method for preventing CRSI of the present invention;

FIG. 3 is schematic diagram of PC operation statistics in the method for preventing CRSI of the present invention; and

FIG. 4 is curve diagram of PC operation statistics in the method for preventing CRSI of the present invention.

### DETAILED DESCRIPTION OF THE INVENTION

The present invention relates to a method for preventing Computer Induced Repetitive Stress Injuries (CRSI) that automatically starts guider based on operation statistics of the computer.

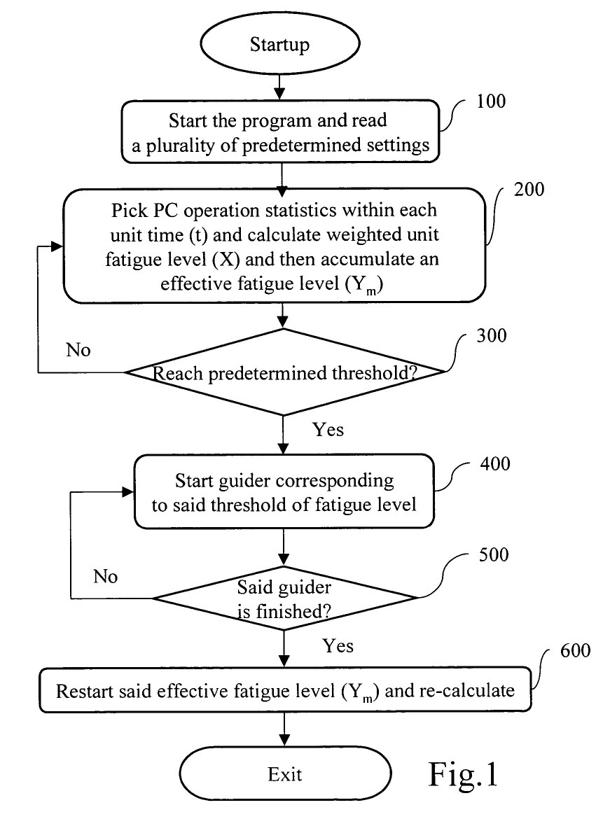

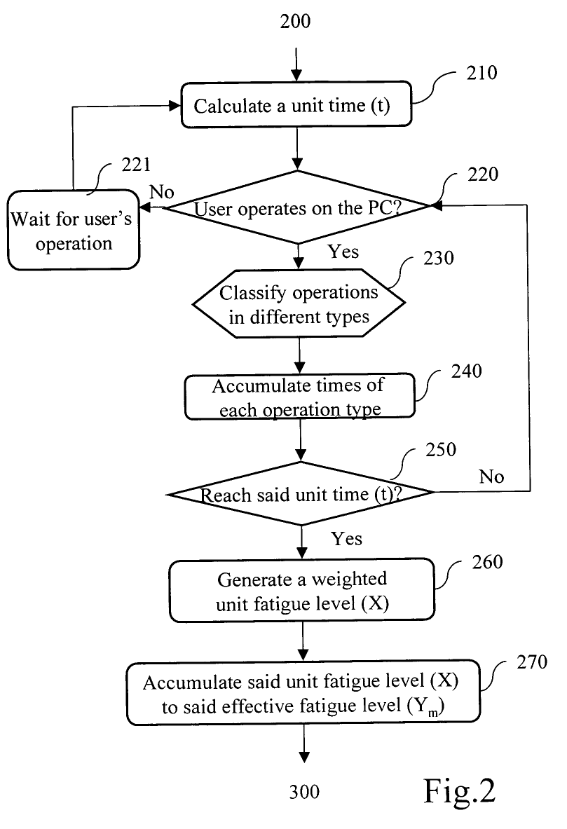

FIG. 1 is schematic diagram of the present invention. Firstly, the user starts the program to read a plurality of predetermined settings (step 100). The program of the present invention is a Terminate and Stay Resident (TSR) program that can be loaded into the operation system at PC startup and generate a clickable icon for the user to set up. Secondly, the program will pick PC operation statistics within each unit time and calculate weighted unit fatigue level and then accumulate an effective fatigue level (step 200). The operation statistics include: keystrokes, clicking of the mouse, mouse scroll, page up and down, etc. Detailed procedure and flow of picking operation statistics please refer to FIG. 2. Then, the program will judge whether the effective fatigue level reaches predetermined threshold (step 300). If it does not reach predetermined threshold, the program will go back to step 200; otherwise, the program will start a guider corresponding to said threshold of fatigue level (step 400). The program judges whether the effective fatigue level reaches predetermined threshold by: (1) Set threshold of fatigue level. The program will start a corresponding exercise when the effective fatigue level reaches predetermined threshold; (2) Set threshold of fatigue level and judge the trend of operation level, which stands for the value of reducing effective fatigue level by previous fatigue level. If the trend of operation level is a negative, it means user's operation on the PC is on falling edge and is a proper time for starting the guider. In short, when effective fatigue level reaches predetermined threshold and the trend of operation level is a negative, the program will start a corresponding guider; (3) Set threshold of fatigue level and judge the trend of operation level. When effective fatigue level reaches predetermined threshold and the trend of operation level is negative, the program will first pop up a count down user reminder for user's feedback confirmation. If user clicks on the reminder or after the count down is finished, a guider will start. If user does not confirm the reminder, the program will postpone the guider to a later proper timing of less busy.

In embodiments, the present invention comprises of a plurality of threshold values of fatigue level, each corresponding to different guider such as eyeball exercise, eye blinking, fist clutching, etc. The guider can be designed in form of transparent screen saver that gently cuts in, or other media files of text, picture and audiovisual film.

Lastly, the program will detect whether said guider is finished (step 500). If it has not finished yet, the program will continue with step 400; otherwise, the program will restart said effective fatigue level and repeat the whole flow.

Said effective fatigue level is calculated with following formula:

Ym=X1²+ . . . +Xm−1²+Xm²−n*Z, in which:

m: Accumulated Time;

n: Fatigue Reduction Times when X=0;

X: Fatigue Level within unit time (t);

Y: Effective fatigue level;

Z: Predetermined Unit Fatigue Reduction Value when X=0.

Said unit fatigue level is caluculated with following formula:

X=a*A+b*B+c*C+d*D, in which:

a, b, c, d: Predetermined Weighted index;

A: Keystrokes;

B: Clicking of the Mouse;

C: Mouse Scroll;

D: Page Up and Down

The calculation formula is adjustable, in which the predetermined weighted index a, b, c and d are adjustable to suit user's need. A, B, C and D are operation statistics in calculating unit fatigue level. Also the program can be furthur improved by incorporating other operation statistics.

FIG. 2 is procedure and flow chart of calculating weighted effective fatigue level in the method for preventing CRSI of the present invention, which illustrates how the present invention calculates said effective fatigue level in main flow step 200. Firstly, the program will calculate a unit time (step 210); and judge whether the user operates on the PC (step 220). If the user does not operate on the PC, the program will wait for user's operation (step 221); if it detects user's operation, the program will furthur classify each operation in different types (step 230) and accumulate times of each opeartion type (step 240), including: keystrokes, clicking of the mouse, mouse scroll, page up and down, etc. The program will also continuously judge whether it has reached said unit time (step 250). If not, the program will continue with flow from step 220 to step 250; otherwise, the program will calculate present weighted unit fatigue level (step 260). The calculation formula please refer to above-mentioned method of calculating unit fatigue level. Then accumulate said unit fatigue level to said effective fatigue level (steop 270). The claculation formula please refer to above-mentioned method of calculating effective fatigue level. Lastly, finish the flow of calculating weighted effective fatigue level and back to main flow step 300.

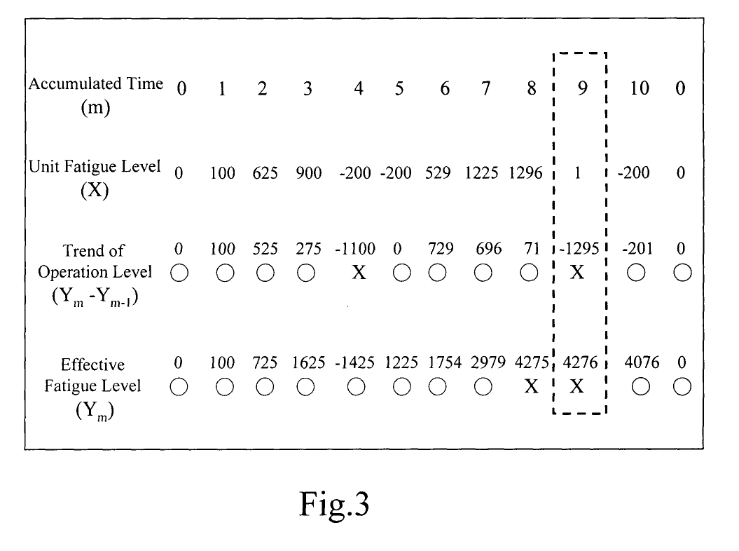

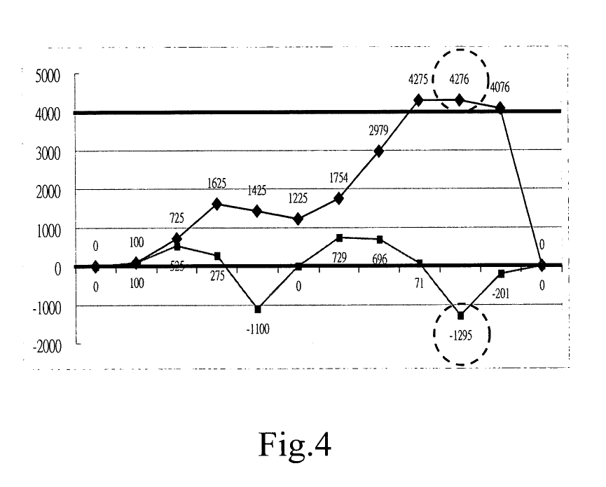

The detailed flow of the present invention is illustarated clearly in FIGS. 1 and 2. The following FIG. 3 and 4 further illustrate some preferred embodiments of the present invention.

The threshold of effective fatigue level is predetermined as 4000 and guider starting criteria as “the effective fatigue level reaches predetermined threshold”. As illustrated in schematic diagram of PC operation statistics in FIG. 3 and in curve diagram of PC operation statistics in FIG. 4, the user's effective fatigue level from PC startup (accumulated time: 0) till the 8th unit time is less than 4000 (actual value: 2979); Then in the 8th unit time, although the effective fatigue level reaches predetermined threshold (actual value: 4275), the guider will not start because the trend of operation level is still a positive (actual value: 71); In the 9th unit time, the effective fatigue level has already reached predetermined threshold 4000 (actual value: 4276) and the trend of operation level turns to a negative (actual value: −1295), the program will start the guider and after finish,, restart the effective fatigue level (accumulated time back to zero).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for preventing Computer Induced Repetitive Stress Injuries (CRSI) that records operation statistics of a computer and calculates computer user's weighted fatigue level and automatically reminds user of necessary guiders to effectively prevent CRSI, comprising:
(a) starting the program and reading a plurality of predetermined settings;
(b) picking PC operation statistics within each unit time (t) and calculating weighted unit fatigue level (X) and then accumulating an effective fatigue level (Ym);
(c) starting corresponding guider when the effective fatigue level reaches predetermined threshold; and
(d) restarting said effective fatigue level (Ym) and re-calculating after said guider is finished.

2. The method for preventing CRSI of claim 1, wherein said effective fatigue level (Ym) accumulated from startup till the m-th unit time (t) is calculated with following formula:
Ym=X₁²+ . . . +Xₘ₋₁²+Xₘ²−n*Z, in which:
m: Accumulated Time;
n: Fatigue Reduction Times when X=0;
X: Fatigue Level within unit time (t);
Y: Effective fatigue level; and
Z: Predetermined Unit Fatigue Reduction Value when X=0.

3. The method for preventing CRSI of claim 2, wherein said unit fatigue level (X) within unit time (t) is calculated with following formula:
X=a*A+b*B+c*C+d*D; in which:
a, b, c, d: Predetermined Weighted index;
A: Keystrokes;
B: Clicking of the Mouse;
C: Mouse Scroll; and
D: Page Up and Down.

4. The method for preventing CRSI of claim 1, wherein said operation statistics comprise of at least keystrokes, clicking of the mouse, mouse scroll, page up and down, etc.

5. The method for preventing CRSI of claim 1, wherein said step (b) further comprises:
calculating a unit time (t);
picking operation statistics and classify operations in different types;
accumulating times of each operation type;
when the time reaches said unit time (t), calculating a weighted unit fatigue level (X); and
accumulating said unit fatigue level (X) to said effective fatigue level (Yₘ).

6. The method for preventing CRSI of claim 1, wherein said step (c) further comprises a threshold of said effective fatigue level; and the program will start the corresponding guider when said effective fatigue level (Ym) reaches said predetermined threshold.

7. The method for preventing CRSI of claim 1, wherein said step (c) further comprises a threshold of said effective fatigue level and a trend of operation level (Ym-Ym-1); and the program will start the corresponding guider when said effective fatigue level (Ym) reaches said predetermined threshold and said trend of operation level (Ym-Ym-1) is a negative value.

8. The method for preventing CRSI of claim 1, wherein said step (c) further comprises a threshold of said effective fatigue level, a trend of operation level (Ym-Ym-1) and a count down user reminder; and when said effective fatigue level (Ym) reaches said predetermined threshold and said trend of operation level (Ym-Ym-1) is negative, the program will start the corresponding guider after user confirms on the reminder.

9. The method for preventing CRSI of claim 8, wherein said step (c) further comprises: when user does not confirm on the reminder, the program will delay the reminder for predetermined period of time and then come back.

10. The method for preventing CRSI of claim 1, wherein said step (c) further comprises a plurality of threshold values of said fatigue level corresponding to different guiders respectively.

11. The method for preventing CRSI of claim 1, wherein said guider comprises of at least an eyeball exercise and an eye blinking reminder with different threshold values of said fatigue level.

12. The method for preventing CRSI of claim 1, wherein said guider further comprises of a user-define media file for playback on screen.

13. The method for preventing CRSI of claim 12, wherein said file can be designed in form of at least text, picture and audiovisual information.

14. The method for preventing CRSI of claim 1, wherein said guider further comprises of a transparent color screen masks that gently cuts in desktop on screen.
